(19) United States
(12) Patent Application Publication
(10) Pub. No.: US 2025/0377660 A1
(43) Pub. Date: Dec. 11, 2025

(54) VEHICLE AND VEHICLE CONTROL INTERFACE BOX

(71) Applicant: TOYOTA JIDOSHA KABUSHIKI KAISHA, Toyota-shi (JP)

(72) Inventors: Kosuke AKATSUKA, Mishima-shi (JP); Ikuma SUZUKI, Okazaki-shi (JP); Hirohito IDE, Nagoya-shi (JP)

(73) Assignee: TOYOTA JIDOSHA KABUSHIKI KAISHA, Toyota-shi (JP)

(21) Appl. No.: 19/035,953

(22) Filed: Jan. 24, 2025

(30) Foreign Application Priority Data
Jun. 10, 2024 (JP) 2024-093419

(51) Int. Cl. G05D 1/227; B60W 60/00; H04L 41/06

(52) U.S. Cl. CPC G05D 1/2274; B60W 60/00; H04L 41/06; B60W 2556/45

(57) ABSTRACT

The automated driving system is configured to output, to the vehicle platform, a command for autonomous driving according to a command from the automated driving system and a command for remote driving according to a command from the outside of the vehicle. During autonomous driving, the vehicle platform determines that an abnormality occurred in communication between the automated driving system and the vehicle platform when a situation in which communication with the automated driving system has been interrupted continues for a first period or longer, and conversely, determines that an abnormality occurred in communication between the automated driving system and the vehicle platform when a situation in which communication with the automated driving system has been interrupted continues for a second period or longer during remote driving. the second period is shorter than the first period.

### CROSS-REFERENCE TO RELATED APPLICATION

This application claims priority to Japanese Patent Application No. 2024-093419 filed on Jun. 10, 2024, incorporated herein by reference in its entirety.

### BACKGROUND

### 1. Technical Field

The present disclosure relates to a vehicle and a vehicle control interface box, and more particularly, to a vehicle that is equipped with an automated driving system and a vehicle control interface box for the vehicle that is equipped with the automated driving system.

### 2. Description of Related Art

Japanese Unexamined Patent Application Publication No. 2018-132015 (JP 2018-132015 A) discloses a vehicle in which an automated driving system is installed. The automated driving system includes a camera, a laser device, a radar device, an operating device, a gradient sensor, automated driving equipment, and an automated driving Electronic Control Unit (ECU) (see paragraph [0023] of JP 2018-132015 A).

### SUMMARY

Some vehicles for mobility services (automated driving vehicles), for example, include a vehicle platform that is configured to be capable of not only autonomous driving but also remote driving. Autonomous driving is driving in accordance with a command that is output, from an automated driving system that is installed the vehicle, to the vehicle platform. Remote driving is driving in accordance with a command that is transmitted from outside of the vehicle (such as a server installed at a remote location, or the like) to the vehicle platform, via the automated driving system.

In the vehicle that is configured as described above, communication between the automated driving system and the vehicle platform may be interrupted. When the situation is not resolved even after a stipulated period elapses following the occurrence of the communication interruption, the vehicle platform (more specifically, a vehicle control interface box, which will be described later) determines that a communication abnormality occurred. It is desirable to be able to appropriately determine whether a communication abnormality is occurring, in both autonomous driving and remote driving.

The present disclosure has been made in order to solve the above problem, and an object of the present disclosure is to provide a vehicle that is capable of appropriately handling communication abnormalities between an automated driving system and a vehicle platform, in both autonomous driving and remote driving.

An aspect of the present disclosure provides a vehicle including a vehicle platform that is configured to execute vehicle control by communicating with an automated driving system.

The automated driving system is configured to output, to the vehicle platform,
a command for autonomous driving in accordance with a command from the automated driving system, and
a command for remote driving in accordance with a command from outside of the vehicle.

The vehicle platform
determines that an abnormality occurred in communication between the automated driving system and the vehicle platform when a situation, in which the communication with the automated driving system is interrupted during the autonomous driving, continues for a first period or longer, and conversely
determines that an abnormality occurred in the communication between the automated driving system and the vehicle platform when a situation, in which the communication with the automated driving system is interrupted during the remote driving, continues for a second period or longer.

The second period is shorter than the first period.

According to the present disclosure, a communication abnormality between the automated driving system and the vehicle platform can be appropriately handled both in autonomous driving and in remote driving, during both autonomous driving and remote driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a vehicle according to an embodiment of the present disclosure;

FIG. 2 is a more detailed view of the configuration of ADK, VP and VCIB;

FIG. 3 is a diagram for describing a communication system between an ADK, a VCIB, and an integrated control manager; and

FIG. 4 is a flow chart illustrating an exemplary process of VCIB of a communication abnormality according to the present embodiment.

### DETAILED DESCRIPTION OF EMBODIMENTS

Hereinafter, embodiments of the present disclosure will be described in detail with reference to the drawings. In the drawings, the same or corresponding portions are denoted by the same reference signs and the description thereof will not be repeated.

### Embodiment

### Overall Configuration

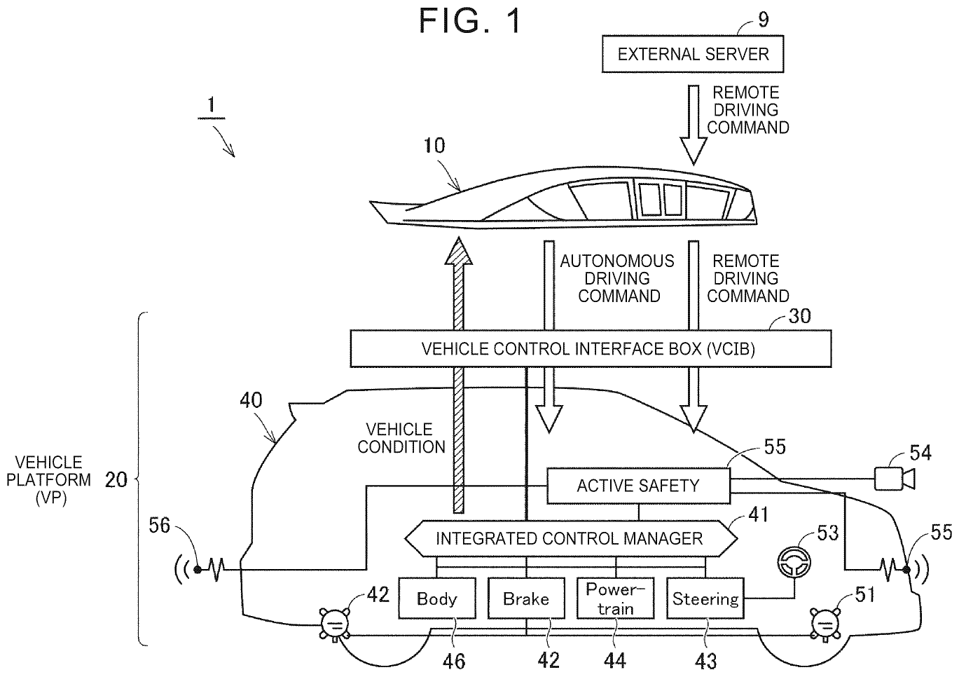

FIG. 1 is a diagram schematically illustrating an overall configuration of a vehicle according to an embodiment of the present disclosure. The vehicle 1 is, for example, an autonomous vehicle for mobility services, and includes Automated Driving Kit (ADK) 10 and Vehicle Platform (VP) 20. VP 20 includes Vehicle Control Interface Box (VCIB) 30 and a base vehicle 40. ADK 10 and VP 20 (the integrated control manager 41 described later) are communicably connected to each other via the vehicle control interface box 30.

ADK 10 is an Automated Driving System (ADS for performing automated driving of the vehicles 1). ADK 10 creates, for example, a travel plan (trip) of the vehicle 1. ADK 10 outputs various control commands (control demands) for causing the vehicle 1 to travel in accordance with the travel plan to VCIB 30 in accordance with an Application Program Interface (API defined for each control command. Further, ADK 10 receives various signals indicating the vehicle state (VP 20 state) from VCIB 30 according to an API defined for each signal. Then, ADK 10 reflects the condition of the vehicle in the travel plan.

ADK 10 outputs an autonomous driving command for VP 20 to perform the autonomous driving to VCIB 30. In addition, ADK 10 is configured to communicate with external servers 9. The external server 9 is managed by a business operator or the like operating the vehicle 1 and is disposed at a remote location (such as a server room of the business operator). ADK 10 receives a remote driving command for VP 20 to perform remote driving from the external servers 9, and outputs the received remote driving command to VCIB 30.

VP 20 has an automated mode and a manual mode. In the auto-mode, VP 20 performs various vehicle controls in accordance with control commands (including autonomous driving and remote driving commands) received from ADK 10. On the other hand, in the manual mode, VP 20 executes the vehicle control according to the user's manipulation.

The base vehicle 40 includes various in-vehicle systems and various sensors. More specifically, the base vehicle 40 includes an integrated control manager 41, a braking system 42, a steering system 43, a powertrain system 44, an active safety system 45, a body system 46, wheel speed sensors 51 and 52, a pinion angle sensor 53, a camera 54, and radar sensors 55 and 56.

The integrated control manager 41 includes a processor such as Central Processing Unit (CPU) and memories such as Read Only Memory (ROM) and Random Access Memory (RAM), all of which are not shown. The integrated control manager 41 integrates and controls the respective systems (the braking system 42, the steering system 43, the powertrain system 44, the active safety system 45, and the body system 46) related to the operation of the vehicle 1.

VCIB 30 is configured to be able to communicate with ADK 10 and the base vehicle 40 through Controller Area Network (CAN) or the like. VCIB 30 receives a control command from ADK 10 and outputs a vehicle condition to ADK 10 by executing a predetermined API defined for each of the signals, commands, and demands. When VCIB 30 receives a control command from ADK 10, the control command is outputted to the control command corresponding to the control command via the integrated control manager 41. Further, VCIB 30 acquires various kinds of information of VP 20 (the base vehicle 40) from various systems via the integrated control manager 41, and outputs the state of VP 20 to ADK 10 as a vehicle state.

It should be noted that ADK 10 may be configured to be attachable to (mounted on) and detachable from the base vehicle 40. Although ADK 10 is shown in FIG. 1 in a position away from the base vehicle 40 for convenience, ADK 10 is actually attached to a rooftop or the like of the base vehicle 40. When ADK 10 is removed, the base vehicle 40 performs vehicle control in the manual mode.

### Configuration of Each Component

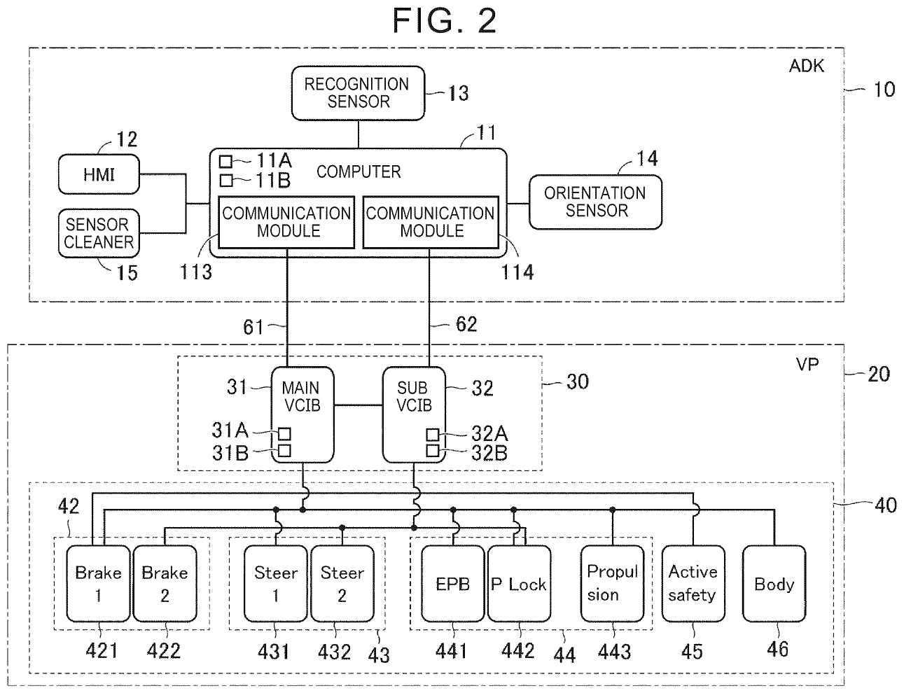

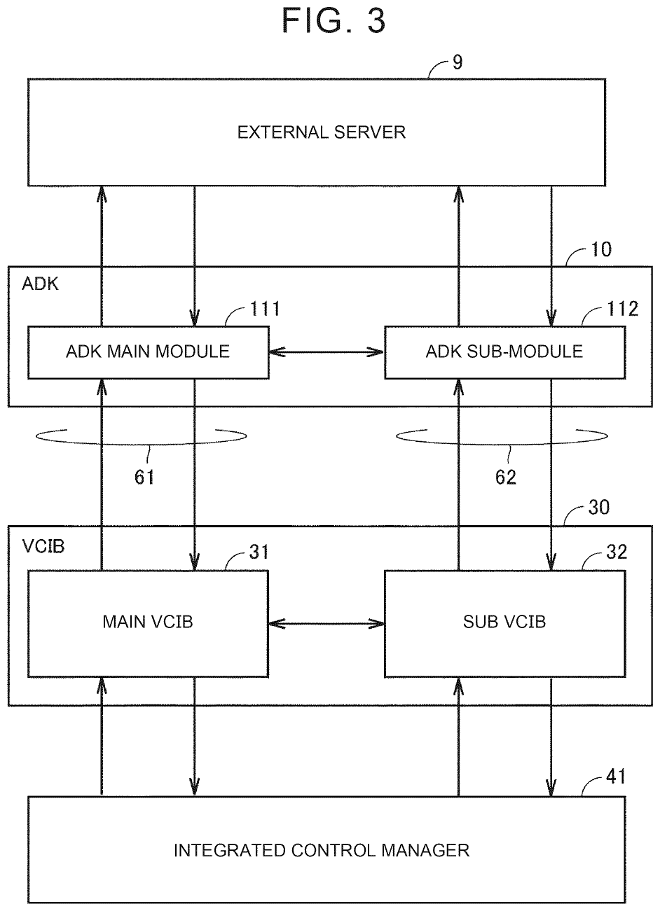

FIG. 2 is a diagram illustrating a configuration of a ADK 10, VP 20 and a VCIB 30 in more detail. FIG. 3 is a diagram for explaining a communication system between ADK 10, VP 20, and VCIB 30.

Referring to FIGS. 2 and 3, ADK 10 includes a computer 11, a Human Machine Interface (HMI) 12, a recognizing sensor 13, an attitude sensor 14, and a sensor cleaner 15.

The computer 11 includes a processor 11A such as a CPU and a memory 11B such as a ROM and a RAM. The memory 11B stores programs executable by the processor 11A. The computer 11 acquires the environment of the vehicle 1 and the attitude, behavior, and position of the vehicle 1 by using various sensors during automated driving of the vehicle 1. At the same time, the computer 11 acquires the vehicle status from VP 20 through VCIB 30 and sets the subsequent operation (acceleration, deceleration, bending, and the like) of the vehicle 1. The computer 11 outputs various control commands for realizing the following operations to VCIB 30.

The computer 11 further includes a ADK main module 111, a ADK sub-module 112, a communication module 113, and a communication module 114.

ADK main module 111 is configured to communicate with a main VCIB 31 (described below) via the communication module 113. ADK sub-module 112 is configured to communicate with a sub-VCIB 32 (described below) via a communication module 114. Further, ADK main module 111 and ADK sub-module 112 are communicably connected to each other. ADK main module 111 and ADK sub-module 112 are configured to wirelessly communicate with external servers 9 (see FIG. 1).

In VP 20, the braking system 42 includes a braking system 421, 422. The steering system 43 includes a steering system 431, 432. The powertrain system 44 includes an Electrical Parking Brake (EPB) system 441, a P-Lock system 442, and a propulsion system 443.

VCIB 30 includes a main VCIB 31 and a sub VCIB 32. The main VCIB 31 includes a processor 31A, such as a CPU, and a memory 31B, such as a ROM and RAM. The memory 31B stores programs executable by the processor 31A. Similarly, the sub-processor includes a processor 32A and a VCIB 32 of 32B. The memory 32B stores programs executable by the processor 32A.

Each of the main VCIB 31 and the sub VCIB 32 relays a control command and information indicating a vehicle-state between ADK 10 and VP 20. The main VCIB 31 and ADK main module 111 are communicably connected to each other by a main bus (corresponding to a “main system” according to the present disclosure) 51. The main VCIB 31 interfaces between VP 20 and ADK 10 (ADK main module 111 through the main bus 61. The sub VCIB 32 and ADK sub module 112 are connected to each other by a sub bus (corresponding to a “sub-system” according to the present disclosure) 62 so as to be able to communicate with each other. The sub VCIB 32 interfaces between VP 20 and ADK 10 (ADK sub-module 112) through the sub-bus 62. Further, the main VCIB 31 and the sub VCIB 32 are communicably connected to each other.

The main VCIB 31 and the sub VCIB 32 have basically the same functions. However, the main VCIB 31 and the sub VCIB 32 are partially connected to VP 20. Specifically, the main VCIB 31, the braking system 421, the steering system 431, EPB system 441, P-Lock system 442, the propulsion system 443, and the body system 46 are communicably connected to each other via a communication bus. The sub VCIB 32, the braking system 422, the steering system 432, and P-Lock system 442 are communicably connected to each other via a communication bus.

In this way, in the vehicle 1, the main VCIB 31 and the sub VCIB 32 have equivalent functions with respect to the operation (braking, steering, etc.) of some systems. In addition, ADK 10 includes a ADK main module 111 and a ADK sub-module 112, and the ADK 10 and the VP 20 are connected to each other by a main bus 61 and a sub-bus 62. As a result, communication between ADK 10, VCIB 30, and the integrated control manager 41 is made redundant.

### Communication Interruption

Basically, communication (signal-exchange) is periodically performed between ADK 10 and VCIB 30 on the main bus 61, and there is a possibility that communication interruption occurs on the main bus 61. When a new command has not been received even after the stipulated period has elapsed since the previous command was received (when the communication interruption has not recovered within the stipulated period), VCIB 30 determines that a communication abnormality has occurred in the main bus 61. VCIB 30 can switch the communication system from the main bus 61 to the sub-bus 62.

Such a communication abnormality may occur both during autonomous driving and during remote driving. It is desirable to be able to appropriately determine the presence or absence of occurrence of a communication abnormality in both the autonomous driving and the remote driving.

A detailed numerical example will be described. Assume that the length of the stipulated period during autonomous driving is set to 20 milliseconds. During the autonomous driving, when a new command is received immediately before the elapse of the stipulated period (for example, after the elapse of 19 milliseconds) after the reception of the previous command, VCIB 30 determines that a communication abnormality has not occurred.

It is also conceivable to set the stipulated period for determining the communication abnormality to the same length (20 milliseconds) as in the autonomous driving even during the remote driving. Here, during remote driving, a delay caused by radio communication between the external servers 9 and VCIB 30 is constantly generated. This delay (hereinafter referred to as “radio delay”) does not occur during autonomous driving. Assume that the radio delay is 10 milliseconds.

During remote driving, when a new command is received immediately before the elapse of the stipulated period after the reception of the previous command (after the elapse of 19 milliseconds), VCIB 30 determines that no communication abnormality has occurred, as in the case of autonomous driving. However, the command received by VCIB 30 may have been outputted from the external servers 9 up to 19 ms+10 ms=29 ms ago. Therefore, during the remote driving, the content of the command received by VCIB 30 may be excessively older than during the autonomous driving, and may not sufficiently follow the change in the condition of the vehicle 1.

In the autonomous driving in which it is conceivable to set the specified time to 10 milliseconds in consideration of the radio delay of 10 milliseconds, if a new command is not received even after 10 milliseconds have elapsed since the previous command was received, VCIB 30 determines that a communication abnormality has occurred. 10 milliseconds is a numerical value calculated by subtracting 10 milliseconds from 20 milliseconds. In this case, since the stipulated period is excessively short, the communication between ADK 10 and VCIB 30 is actually normal, but there is a possibility that the frequency of erroneously determining that a communication abnormality has occurred is high.

Therefore, in the present embodiment, the stipulated period (the second stipulated period T2) during the remote driving is set shorter than the stipulated period (the first stipulated period T1) during the autonomous driving. For instance, the first stipulated period T1 during autonomous driving is set to 20 milliseconds, while the second stipulated period T2 during remote driving is set to 10 milliseconds. The first stipulated period T1 and the second stipulated period T2 correspond to the “first period” and the “second period”, respectively.

Then, during the remote driving, if a new command is not received even after 10 milliseconds has elapsed since the previous command was received, VCIB 30 determines that a communication abnormality has occurred. In other words, only when the timing at which the signal is outputted from the external server 9 is at most 10 milliseconds+10 milliseconds=20 milliseconds earlier, VCIB 30 determines that a communication abnormality has not occurred. Therefore, it is possible to prevent the content of the command received by VCIB 30 from the external servers 9 during the remote driving from being excessively old.

On the other hand, during autonomous driving, when a new command is not received even after 20 milliseconds or more has elapsed from the previous signal, VCIB 30 determines that a communication abnormality has occurred. When the duration from the previous command is less than 20 milliseconds, VCIB 30 does not determine that a communication abnormality has occurred. Since the length of the stipulated period is appropriate, it is possible to suppress an increase in the frequency of erroneous determination that a communication abnormality has occurred despite normal.

### Process Flow

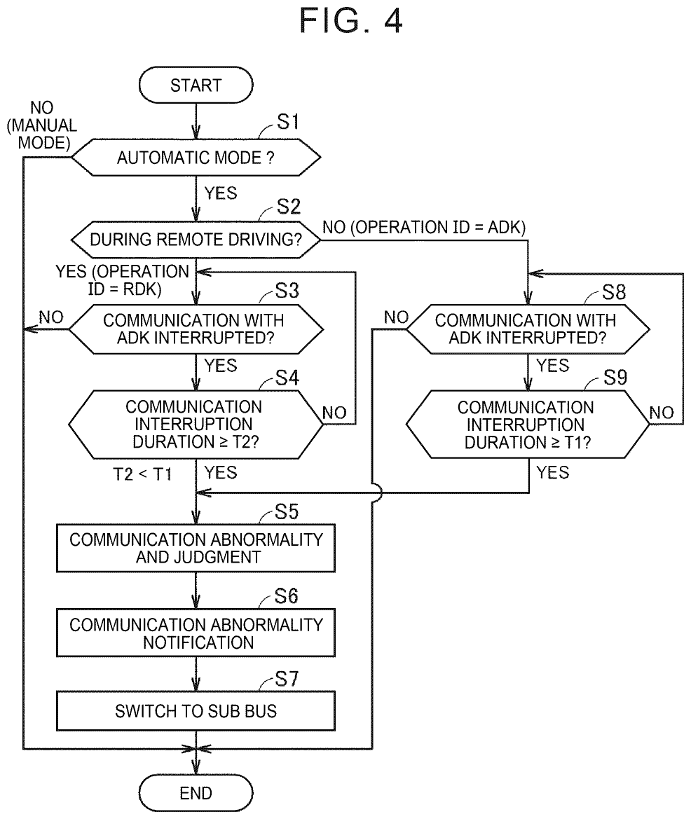

FIG. 4 is a flow chart illustrating an exemplary process of VCIB 30 of a communication abnormality according to the present embodiment. The process illustrated in this flow chart is called and executed by a main routine (not illustrated) when a predetermined condition is satisfied (for example, every predetermined cycle after a travel plan is created by ADK 10). The steps are implemented by software processes by VCIB 30 (main VCIB 31 and/or sub-VCIB 32), but some or all of them may be implemented by hardware (electric circuitry) arranged in ECU. Hereinafter, the step is abbreviated as S.

In S1, VCIB 30 determines whether VP 20 is in auto-mode. When VP 20 is in the manual mode (NO in S1), VCIB 30 skips the subsequent processing and returns the processing to the main routine. If VP 20 is auto-mode (YES in S1), VCIB 30 proceeds to S2.

In S2, VCIB 30 determines whether VP 20 is during remote driving. VP 20 includes RDK that is a driving ID indicating that VP 20 is during remote driving and ADK that is a driving ID indicating that VP 20 is during autonomous driving. If VP 20 is during remote driving and in driving ID=RDK (YES in S2), VCIB 30 proceeds to S3.

In S3, VCIB 30 determines whether communication between ADK 10 and VCIB 30 is interrupted. If the communication is not interrupted (NO in S3), VCIB 30 returns the process to the main routine. When communication is interrupted (YES in S3), VCIB 30 determines whether or not the period during which communication between ADK 10 and VCIB 30 is interrupted (hereinafter, abbreviated as “communication interruption period”) is equal to or greater than the second stipulated period T2 (S4). The second stipulated period T2 is set to be shorter than the first stipulated period T1.

If the communication interruption period is less than the second stipulated period T2 (NO in S4), VCIB 30 returns the process to S3. When the communication interruption period is equal to or larger than the second stipulated period T2 (YES in S4), VCIB 30 determines that a communication abnormality has occurred (S5). Then, VCIB 30 notifies the integrated control manager 41 of the base vehicle 40 of the occurrence of the communication abnormality (S6). In addition, VCIB 30 switches the communication between ADK 10 and VCIB 30 from the communication by the main bus 61 to the communication by the sub-bus 62 (S7). VCIB 30 then returns the process to the main routine.

In S2, when VP 20 is in the autonomous driving state and is in the driving ID=ADK (NO in S2), VCIB 30 advances the process to S8.

In S8, VCIB 30 determines whether communication between ADK 10 and VCIB 30 is interrupted. If the communication is not interrupted (NO in S8), VCIB 30 returns the process to the main routine. If the communication is interrupted (YES in S8), VCIB 30 determines whether the communication interruption period is equal to or greater than the first stipulated period T1 (S9).

If the communication interruption period is less than the first stipulated period T1 (NO in S9), VCIB 30 returns the process to S8. When the communication interruption period is equal to or larger than the first stipulated period T1 (YES in S9), VCIB 30 determines that a communication abnormality has occurred (S5). Then, VCIB 30 notifies the integrated control manager 41 of the occurrence of the communication abnormality (S6). In addition, VCIB 30 switches the communication between ADK 10 and VCIB 30 from the communication by the main bus 61 to the communication by the sub-bus 62 (S7). VCIB 30 then returns the process to the main routine.

As described above, in the present embodiment, the radio delay is taken into account, and the second stipulated period T2 during the remote driving is set shorter than the first stipulated period T1 during the autonomous driving. In this way, it is possible to prevent the content of the command outputted from the external servers 9 and received by VCIB 30 from being excessively older during the remote driving. Further, during the autonomous driving, it is also possible to suppress that the frequency of erroneous determination that a communication abnormality has occurred despite normal communication between ADK 10 and VCIB 30 increases. Therefore, according to the present embodiment, it is possible to appropriately cope with the communication abnormality between ADK 10 and VCIB 30 both during the autonomous driving and during the remote driving.

It is to be understood that the embodiments disclosed herein are illustrative and non-restrictive in all respects. It is intended that the scope of the disclosure be defined by the appended claims rather than the description of the embodiments described above, and that all changes within the meaning and range of equivalency of the claims be embraced therein.

What is claimed is:

1. A vehicle comprising a vehicle platform that is configured to execute vehicle control by communicating with an automated driving system, wherein:
the automated driving system is configured to output, to the vehicle platform,
a command for autonomous driving in accordance with a command from the automated driving system, and
a command for remote driving in accordance with a command from outside of the vehicle;
the vehicle platform
determines that an abnormality occurred in communication between the automated driving system and the vehicle platform when a situation, in which the communication with the automated driving system is interrupted during the autonomous driving, continues for a first period or longer, and conversely
determines that an abnormality occurred in the communication between the automated driving system and the vehicle platform when a situation, in which the communication with the automated driving system is interrupted during the remote driving, continues for a second period or longer; and
the second period is shorter than the first period.

2. The vehicle according to claim 1, wherein:
the vehicle platform includes
a base vehicle, and
a vehicle control interface box for interfacing between the automated driving system and the base vehicle; and
upon receiving a command from the automated driving system during the autonomous driving or during the remote driving, the vehicle control interface box outputs a signal corresponding to the command that is received, to the base vehicle.

3. The vehicle according to claim 2, wherein the vehicle control interface box notifies the base vehicle that an abnormality occurred in the communication between the automated driving system and the vehicle platform.

4. The vehicle according to claim 2, wherein:
the vehicle control interface box is configured to interface between the automated driving system and the base vehicle, via one of a main system and a sub-system; and
when an abnormality occurs in communication via the main system, communication systems are switched so as to perform communication via the sub-system.

5. A vehicle control interface box that is installed in a vehicle, the vehicle control interface box comprising a processor that interfaces between an automated driving system and a base vehicle, wherein:
the automated driving system is configured to output, to the base vehicle,
a command for autonomous driving in accordance with a command from the automated driving system, and
a command for remote driving in accordance with a command from outside of the vehicle, via the vehicle control interface box;
the processor
determines that an abnormality occurred in communication between the automated driving system and the base vehicle when a situation, in which the communication with the automated driving system is interrupted during the autonomous driving, continues for a first period or longer, and conversely
determines that an abnormality occurred in the communication between the automated driving system and the base vehicle when a situation, in which the communication with the automated driving system is interrupted during the remote driving, continues for a second period or longer; and
the second period is shorter than the first period.
